(19) United States
(12) Patent Application Publication
(10) Pub. No.: US 2009/0083132 A1
(43) Pub. Date: Mar. 26, 2009

(54) METHOD AND SYSTEM FOR STATISTICAL TRACKING OF DIGITAL ASSET INFRINGEMENTS AND INFRINGERS ON PEER-TO-PEER NETWORKS

(75) Inventors: Necip Doganaksoy, Niskayuna, NY (US); Angshuman Saha, Bangalore (IN); Joseph Cates, San Marino, CA (US); Aaron Shaw Markham, Pasadena, CA (US); Jayanth Kalle Marasanapalle, Bangalore (IN); Michelle My-Ly Huynh, Alhambra, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/233,705

(22) Filed: Sep. 19, 2008

Related U.S. Application Data
(60) Provisional application No. 60/974,020, filed on Sep. 20, 2007.

(51) Int. Cl. G06Q 10/00; G06Q 50/00

(52) U.S. Cl. 705/11; 705/7

(57) ABSTRACT

Tracking digital asset infringement activities and infringers on peer-to-peer networks. One method for assessing notice effectiveness of unauthorized distributors of content on a peer-to-peer network comprises processing peer data from a plurality of peers on the network, wherein the peer data aids in identification of individual unauthorized distributors. The embodiment includes creating a trial with a trial base population of the unauthorized distributors and a trial capture window, determining metrics for measuring the notice effectiveness, selecting a randomization methodology for the trial, performing the trial with the trial base population over the trial capture window according to the randomization methodology and issuing notices to some of the unauthorized distributors. The method also includes characterizing the unauthorized distributors into characterized data of at least one of characterization of unauthorized distribution activity and characterization of notice actions, and segmenting the characterized data into groupings according to one or more variables.

### CROSS REFERENCE TO RELATED APPLICATIONS

This application claims the benefit of U.S. Provisional Applications No. 60/974,020, filed Sep. 20, 2007, which is herein incorporated in its entirety by reference.

### BACKGROUND OF THE INVENTION

Piracy of digital assets on peer-to-peer networks leads to losses by content owners estimated in billions of dollars annually. This harmful activity affects the public as the costs for legitimate products are increased. A study by an international consulting firm in 2005 concluded that “major U.S. motion picture studios lost $6.1 billion in 2005 to piracy worldwide” and that 38% of the loss was attributed to Internet piracy. And, this number has grown significantly. Thus, piracy is a scourge on the public that continues to proliferate unabated.

The problem associated with improper content distribution is augmented by the peer-to-peer network systems. In a client-server approach where there is a single content source on a server and client's communicate with the server for content. The peer-to-peer (P2P) network provides an efficient mechanism to disseminate content to multiple users. In a P2P network, the content is distributed among multiple peers and the peers generally share the content with each other. While the P2P network is an excellent tool for distributing content, it lends itself to abuse by parties that improperly distribute works.

In a typical P2P network, there is some digital content that is subject to P2P distribution. The content is typically divided into pieces according to the respective P2P protocol, wherein peers distribute the pieces amongst themselves. The peers share their pieces and try to obtain a complete copy of the content. The content may be initially stored on some origin seed peer that also participates in the P2P sharing and helps distributes the pieces of the content among the peers. The content can be legitimate materials that the content provider wishes to disseminate, but can also be material that the content provider does not want distributed, such as new movies, books, music and videos.

Information about the content typically includes certain information such as the title or keywords that would likely be used in identifying the subject matter to be distributed. The peer prospects can search the Internet for the content using the identifying information or otherwise learn about the content from other users, websites or really simple syndication (RSS) feeds. This information may include identifying address of a tracker that is generally deployed in the P2P network such that peers register with the tracker in order to obtain addresses of the various peers in the network involved in the content distribution. Once the peers have the IP addresses of other peers in the network, they initiate communications with those peers to exchange content. It should be understood by those skilled in the art that there are numerous flavors of the P2P networks as well as a number of protocols that allow for different operational parameters.

Content owners are those that have the control or ownership of certain content. By way of example, a work can be owned by the creator or may be conveyed by assignment or license. The content can be, for example, a new movie, and the owner wishes to regulate the dissemination of the content to ensure that only legitimate and high quality copies of the content are distributed and that the owner is properly compensated. According to the copyright laws, the content owner has certain rights that include the right to copy and distribute such copies. Unauthorized distribution of such works is considered an infringement. The copyright laws in the U.S. were amended under the Digital Millennium Copyright Act (DCMA), to specifically address copyright infringement on the Internet such as peer-to-peer activities, and the content owner was given tools to aid in reducing unauthorized distribution of copyrighted works. One of the features of the DCMA includes a process for notifying the Internet Service Providers (ISPs) about unauthorized distribution activity and potentially shutting down the unauthorized distributor unless the improper activity is halted.

Contents owners utilize a variety of techniques to attempt to track and monitor infringement activity involving their assets on peer-to-peer networks. In 2006, for example, a tracking vendor detected about millions of unauthorized distributions on just a few peer-to-peer networks. This piracy issue is even more pervasive on a global scale with only about 10% of the unauthorized distributions originated from U.S. Internet Service Provider (ISP) users.

In an effort to combat piracy activities, antipiracy technology has been developed to help monitor P2P network activity and/or identify the alleged unauthorized distributors and propagators of digital content over P2P networks. This has helped spawn an industry for third party monitoring service providers to aid the owners of digital content. One well-known example of a monitoring company is BayTSP although there are many other companies in this field.

In one scenario, the content owner provides the third party monitoring service with a list of copyrighted digital content that it wishes to protect from improper distribution or otherwise believes may be the subject of infringing activity. This is particularly relevant to motion pictures that are new or recently released.

The monitoring systems attempt to detect the unauthorized distribution of the digital content over various P2P networks along with some identification of the propagators. To determine whether certain specific digital content is being offered on the P2P network, the monitoring service provider connects to the P2P networks and searches for users who are offering copies of the content, typically using crawlers.

Since the digital content is typically large, the file is divided into pieces according to the P2P protocol being utilized in the distribution, wherein a number of users or peers each may have pieces of the file and swap the pieces among each other.

When a P2P peer searches for a particular content file, many different P2P peers are identified as having a copy of portions of that content on their shared directory and enables the requesting peer to download the pieces of content file. As a peer obtains pieces of the content file, these pieces become available for download by other peers.

One of the technical processes used by crawlers to identify users who are propagating digital content over the Internet is that during a download of a piece of the content file, the crawler executes an evidence gathering software program that obtains peer identifying information while the content is downloading. One such identifying data is the IP address.

The dynamic IP address is a unique numerical identifier that is automatically assigned to a user by its Internet Service Provider (ISP) each time a user logs on to the network. Although a subscriber may be assigned a different IP address at each login, ISPs are assigned certain blocks or ranges of IP addresses that help the identification process. In addition, ISPs keep track of the IP addresses assigned to its subscribers at any given moment and retain user logs of their activity. Thus, the ISP can identify a specific ISP subscriber by the IP address and the date and time of interest and use the user logs to further identify the name and address of the ISP subscriber who was assigned that IP address at that date and time.

In addition to the content file and IP address, some monitoring services also simultaneously download other publicly available identifying information from the network user. For example, from each participant in the swarm that provided some content file to the monitoring peer (e.g.: crawler), the crawler can download and record for each file downloaded: the video file's metadata (digital data about the file), such as its title and file size, which is not part of the actual video content but that is attached to the digital file and helps identify the content of the file; the time and date at which the file was downloaded from the user; the IP address assigned to each user at the time of activity; and the percentage of the file the user is offering on his or her computer. This information is generally used to create evidence logs about each user and stored for subsequent processing. The content owner can utilize the information from the monitoring service to confirm that the file downloaded was an improper distribution of copyrighted content.

Some of the P2P systems also enable identification of a peer via a hash code identifier. The hash identifier is typically a binary number automatically assigned by the P2P system upon various conditions. In one example, as soon as a peer in the swarm has a complete copy of the content file that is made available for sharing on the P2P network, the P2P software automatically assigns a unique Hash Identifier or number to that file. This uniquely identifies that file and the associated pieces within the network that are subsequently disseminated to other peers. Therefore, a peer who has a portion of the file with the same hash number as the hash number assigned to the first peer's complete file, must have obtained that file either directly or indirectly from that first propagator.

To find the propagator of the content file on the P2P network, the monitoring service can search the network until it finds the first instance of a particular copy of the digital asset identified by the specific hash number. There are several characteristics that allow the monitoring service to confirm its determination of the first propagator of a specific digital content on the P2P network. For example, the monitoring service runs continuously and searches for particular titles on the P2P network so that it maintains information about the network with respect to the searched titles. This ensures that the monitoring service can quickly ascertain any changes on the network with respect to the monitored titles and quickly participate in the sharing to gather information. With respect to new content, this monitoring is enhanced when it cooperates with the content owner and has knowledge of the date/time of a release that is subject to improper copying and distribution.

The monitoring service may also determine the percentage of the total files held by a peer in the swarm and any peer that has a complete copy early in the swarm is likely to be a first propagator. If a particular user is both the first in time to appear on the P2P network with a unique copy, identified by a unique hash number, of the digital content and appears on the network with the complete digital file, then that peer is the first propagator on the P2P network.

In addition to passive monitoring, content owners employ various methods towards reducing such activity. They take a number of steps to attempt to peaceably stop the infringing activity, including using certain provisions of the Copyright laws. For example, they send cease-and-desist letters (a.k.a “notices”) to the ISP of the infringers since content owners typically do not have the ability to identify the individual infringers beyond his/her IP address and other similar attributes. ISPs vary greatly in their handling of these notices (i.e., the compliant ISPs forward the letters to the infringing users and, in some cases, stop their broadband access. Non-compliant ISPs do not take an action on the notice letters.)

The infringement data is typically used by content owners for descriptive summaries such as total count of infringements over a period of time, total number of notices served over a period of time, and breakdown of the above by ISP, geography and asset name.

However, content owners typically lack the ability to translate the voluminous infringement tracking data into actionable business information. More specifically, some the questions of interest are: What are the basic characteristics of the infringers? How often does the infringement occur? Is the infringement sporadic, periodic or continuous? What are the distinct sub-groups within the infringer population? Are the notices indeed effective? The answers to such questions help the content owner to optimize the utilization of their anti-piracy resources.

Unfortunately there is limited business intelligence from data gathered on peer-to-peer networks involving unauthorized distributions and not much has been done in terms of analytics of the Internet piracy data, particularly with respect to a commercial or industrial setting. Thus, the state of the art technology has not been able to provide assistance to content owners and related parties in deterring and administering the unauthorized distribution of digital assets.

### BRIEF DESCRIPTION

One embodiment relates to unauthorized distribution of copyrighted content, and more particularly, to efforts to curtail the detrimental effects thereof.

One embodiment is a method for dealing with unauthorized distributors of content on a peer-to-peer network, comprising processing data from a plurality of peers and identifying an individual unauthorized distributor, characterizing the data to produce characterized data, segmenting the characterized data into groupings according to one or more variables, and reporting results of the segmenting.

In one aspect, the characterizing is based on overall data from at least one of characterization of unauthorized distribution activity and characterization of notice actions.

The variables according to one example comprises at least one of statistical summary of unauthorized distribution actions by digital asset type, infringement duration by digital asset type, notice actions by digital asset type, statistical summary of unauthorized distribution actions by unauthorized distributor type, infringement duration by unauthorized distributor type, notice actions by unauthorized distributor type.

The method may further comprise assessing notice effectiveness, wherein an example of the notice effectiveness includes creating a trial with a trial base population of the unauthorized distributors and a trial capture window for the trial, determining metrics for measuring the effectiveness, and performing the trial with the trial base population over the trial capture window. A randomization methodology can be implemented, wherein the randomization methodology is a grouping of the unauthorized distributors into at least two groups, the groups comprising a notice group and a no-notice group.

One embodiment of the invention is a method for assessing notice effectiveness of unauthorized distributors of content on a peer-to-peer network, comprising processing peer data from a plurality of peers on the network, wherein the peer data aids in identification of individual unauthorized distributors. This also includes creating a trial with a trial base population of the unauthorized distributors and a trial capture window for the trial, determining metrics for measuring the notice effectiveness; selecting a randomization methodology for the trial and performing the trial with the trial base population over the trial capture window according to the randomization methodology and issuing notices to some of the unauthorized distributors. Other aspects include characterizing the unauthorized distributors into characterized data of at least one of characterization of unauthorized distribution activity and characterization of notice actions, segmenting the characterized data into groupings according to one or more variables, and reporting results of the notice effectiveness.

Another embodiment is a system for combating unauthorized distribution of content files on a peer-to-peer network, the system comprising a storage medium containing peer information of peers participating in the peer-to-peer network for the content files, and a computer readable medium comprising computer executable instructions processing the peer information and apriori information that uniquely identifies individual unauthorized distributors, issuing notices to some of the unauthorized distributors, further comprising characterizing the unauthorized distributors and segmenting the unauthorized distributors into groups. A display can be used to illustrate the results. One aspect of the present system is that it provides opportunities for companies to provide services to interested studios and copyrighted content providers.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a basic system diagram configured in accordance with one embodiment.

FIG. 2 is a simplified flowchart showing the processing according to one embodiment.

FIG. 3a is a flowchart showing one embodiment for characterization.

FIG. 3b is a flowchart showing a randomized trial processing configured in accordance with one embodiment.

FIG. 4 is an example of actual data involving unauthorized downloads for particular protocols.

FIG. 5 is a further illustration of actual data involving unauthorized distributions for a number of U.S. ISPs.

FIG. 6 is an illustration of actual data involving unauthorized distributions for a number of international ISPs.

FIG. 7 is a presentation of an unauthorized distributor and a timeline of the unauthorized distribution activity.

FIG. 8 illustrates the percentage of returning infringers for several ISPs and the difference between the notice groups and those with no notices.

FIG. 9 is a diagram illustrating notice sending and infringer response metrics.

### DETAILED DESCRIPTION

One general embodiment of the present system and methods detailed herein enable some degree of control from unauthorized distribution of digital assets distributed by peer-to-peer networks. As used herein, the term digital asset refers to any form of content that can be provided into a digital form and includes such works as music, speeches, videos, movies, televised matter, photographs, computer games, software, books and related materials. As used herein, unauthorized distribution refers to the dissemination of digital assets without permission or other legal rights. Similarly, with respect to a P2P network, an unauthorized distributor is any peer participant involving unauthorized digital assets whether transmitting or receiving any pieces of such assets.

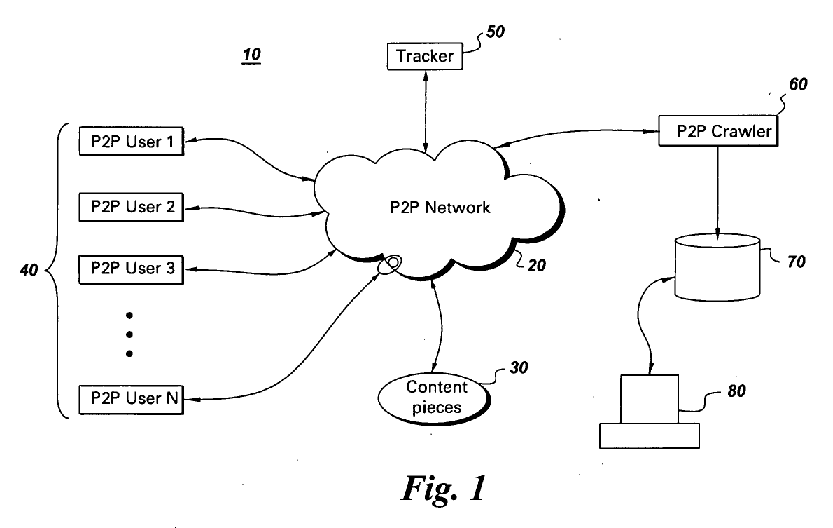

FIG. 1 presents an exemplary illustrative system overview 10 of infringement data gathering using crawlers on a peer-to-peer network and processing therein. This example is presented for illustrative purposes to explain the system and processing and should not be considered limited to any specific system or protocol.

In this system 10, there is a P2P network 20 having multiple peers 40 that are participating in the P2P exchange of content pieces 30, typically called a swarm, in order to obtain a complete copy of the content. In one example, the content may initially reside on an origin seed (not shown), which is a peer that contains a complete copy of the content. The origin seed may depart from the swarm once at least one copy of the content is distributed. In a legitimate distribution, the content file is typically provided by the content provider and is prepared for sharing. In an unauthorized distribution, a copy of some content is made available on the P2P network without authorization. The unauthorized copy may also be inferior in terms of quality.

Some basic information on P2P is provided for an understanding of the processing in one example. The content file is generally packaged in a format that adheres to the respective P2P protocol being used for the dissemination that may entail generating cryptographic hash values for each of the pieces to ensure their integrity, as well as generating a cryptographic hash of the entire content set. These hashes are placed in a metafile describing the information about the content to be distributed. The content data itself can be any form of digitized data and may consist of one or more files or folders.

Once the content file has been packaged according to the appropriate P2P requirements, the content is registered with some form of tracker 50 and typically a complete copy is placed on some origin seed. The metafile with the information about the content is published, such as by placing the metafile information on a website or a syndication feed (e.g., an RSS feed). The metafile information typically includes tracker information that allows a peer to communicate with the tracker 50 to obtain the IP addresses of other peers in the swarm.

Peers 40 join the P2P network 20 by downloading the metafile and registering with the tracker 50 to initiate the transfer process. Upon request, the tracker 50 supplies a requesting peer with a list of other peers 40 in the swarm. The tracker 50 may use some peer selection processing to determine which peers 40 to distribute to a requesting peer. When the requesting peer receives a peer-list from the tracker 50, it attempts to connect to the peers 40 specified on the provided peer list. Peers 40 exchange content pieces 30 with connected peers participating in the swarm. At some point, a peer may leave the swarm after obtaining a full copy of the content.

In this embodiment, one or more P2P crawlers 60 also participate in the P2P activity in order to gather data. The content owner may provide keywords or other identifying information about its digital assets that it wishes to protect from the unauthorized distribution. The P2P crawler 60 would act as a peer by obtaining the metafile with the tracker identification or otherwise requesting a peer list from the tracker to obtain the content pieces 30. There are tracker-less P2P networks wherein one or more peers function like a tracker 50 and facilitate the distribution of a peer list, however as used herein, the term tracker 50 shall refer to the tracker functionality and not necessarily a separate tracker server.

According to one embodiment, the P2P crawlers 60 search for peer-to-peer swarms that involve distribution of certain digital assets. Once located, the crawler 60, acts like a peer, and participates in the swarm. The P2P crawler 60 requests one or more content pieces 30 from other swarm participants in the P2P network 20. The crawler 60 records identifying information upon receipt of a segment of a file from another swarm participant. The identifying information may include such information as the IP address of the peer, the name of the file, and a time stamp.

The data obtained from the P2P crawler 60 can be communicated to a storage location 70 for subsequent processing. The storage location 70 can be any type of data storage with sufficient capacity to store the extracted information. In one embodiment the data is stored and processed locally. In a further embodiment the data is stored locally but transmitted elsewhere for subsequent processing to a computing device 80. In a yet further embodiment, the data is transmitted to one or more other locations for processing.

The longer the P2P crawler 60 participates in the swarm, the more identifying information about the peers 40 will be retrieved. In addition, there may be multiple P2P crawlers 60 participating in the same swarm allowing for gathering more information in a shorter period of time. The crawlers 60 can also be gathering information from multiple swarms allowing for identification of those that participate more actively in non-authorized distribution of digital assets.

The computing device 80 processes the data to identify and categorize the various peers 40. Based on the processing, various actions can be undertaken to stop the peers from future unauthorized distributions.

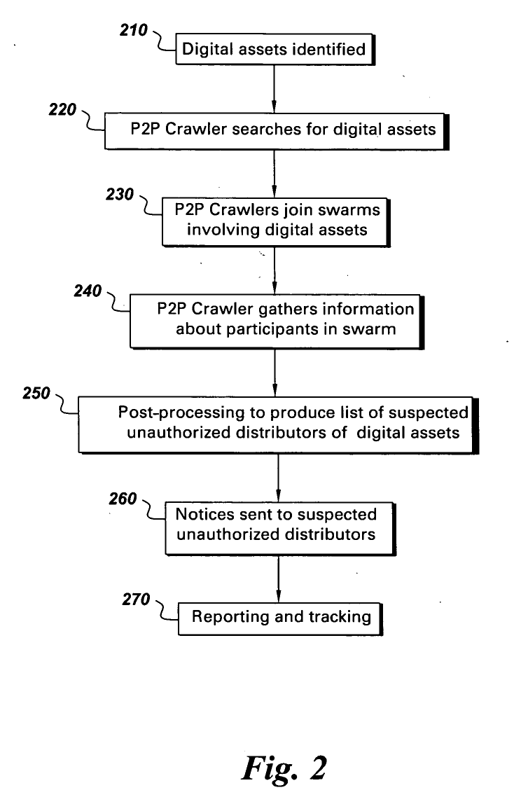

Referring to FIG. 2, a simplified flowchart is depicted noting some of the process steps according to one embodiment. The digital assets are identified 210, such as by keywords using titles, names, and related identifying information. The identifiers can be continuously modified to include new titles, but they can also contain more static information such as company names such as Disney or Pixar.

The P2P crawler searches for the digital assets 220, typically by using the keywords and identifiers for the digital assets of the content owner. The P2P crawler may employ search engines or visit sites that list available content or searchable listings. In some cases, information about content is distributed by RSS feeds or email, and the P2P crawler can use these resources. There may also be website portals that allow peers to register for certain content when it becomes available, and the P2P crawler may also register on these sites and services.

A further embodiment can employ apriori knowledge to aid in identifying the source of unauthorized distribution wherein P2P crawlers target known or suspected P2P distributors and enter into swarms associated with such distributors.

Once the P2P crawler is alerted to a swarm with possible unauthorized distribution, the P2P crawler joins the swarm 230. Unlike the other peer participants that are only seeking to obtain a complete copy of the distributed digital asset, the P2P crawler is interested in data gathering and monitoring activities about the participants in the swarm 240. Once the P2P crawler obtains a list of peers, it attempts to communicate with the peers by requesting the content pieces. Since the P2P crawler is behaving like another peer, the other peers have no knowledge that the P2P crawler is also logging information about the swarm and the various peers in the swarm. The peers that communicate with the P2P crawler provide certain information with identifying details. The identifying information is logged by the P2P crawlers and that information is stored or transmitted to another location for subsequent processing.

One embodiment employs identification post-processing 250 to characterize the suspected unauthorized distributors. According to one embodiment, the suspected unauthorized distributors are characterized according to various traits and behavior. The characterization is used to develop a list of suspected unauthorized distributors of the digital assets.

Once the list of suspected unauthorized distributors is generated, a notification program is commenced and notices are sent out reporting the details of the unauthorized distribution 260. In one example, notices are sent to the suspected unauthorized distributors. The type of notice and timing of the notification can be based on the behavior and characteristic traits of the unauthorized distributor. For example, a first time offender portraying certain traits may obtain a certain type of informative notification whereas a notable active offender may receive a different form of notification. In certain cases, the notification processing includes notifying the ISP of the improper usage, wherein a vigilant ISP may take action by informing the user of the allegations involving the unauthorized distribution. Such actions by the ISP may include ceasing service to a user.

In one embodiment, the notices provided to the ISP's are in accordance with the guidelines promulgated by the legal authorities such as the DCMA in the United States or the EU Copyright Directive (EUCD) in Europe. Such legislation provides a safe harbor provision for ISPs that have users performing improper activities, provided the ISP follows certain procedures. There are a number of initiatives throughout the world addressing the piracy conducted over the Internet and various laws and legislation have provisions and directions for notification and enforcement. The notification processing detailed herein can be adaptable for the specifics of the various legislative guidelines and directives as appropriate.

The system also provides reporting and tracking 270 for the notification processing and the subsequent activity. The results of the identification and notification processing can be communicated back to the data gathering processing. In one embodiment the system processing provides some measure of response effectiveness quantification.

In one embodiment, the response or lack of response by the suspected unauthorized distributor and/or ISP is logged and appropriate follow-up measures can be undertaken. By employing a methodical approach to identifying and notifying the suspected unauthorized distributors, the content owner or licensee can at last exercise some control over the situation. Content owner as used herein can refer to the various licensees or other representatives such as enforcement agencies that are acting on behalf of the content owner.

The identification processing of the unauthorized distributor varies depending upon the P2P protocol, ISP, and other factors. The identification processing typically seeks to obtain as much data as is possible about a suspected unauthorized distributor which may include user ID, user hash, user IP address, protocol, file name, file size, date/time of activity, registration identification, email address, user name. While the suspected unauthorized distributor is sometimes easily identified, additional processing may be utilized along with additional resources. A complaint ISP can generally provide the unique identification of an infringer.

In some embodiments, the P2P protocols provide a user ID that can be used to uniquely identify the party involved in the unauthorized distribution. In other cases, the user IP address can sometimes be used to uniquely identify the party of concern. In still other examples, the unauthorized distributor may register with identifying information that can be used for the identification processing.

According to one embodiment, the system possesses the capability to identify and track individual users. By way of illustration, Tables A and B display an example of 10 records from an interface between crawlers and peers participating in various swarms, indicating one example of identification processing.

In this example, a P2P User ID provides a unique identification. This is facilitated through a unique ID number that each user gets assigned upon installment of the peer-peer client on their computer. This enables us to develop analytics towards

TABLE A

| Identification | User Name | IP address | Date/Time |
|---|---|---|---|
| 15532375 | HighID\|1181305959\|2B118AD58D0E03531DAAF9E4BFDD6FC4 | 70.105.76.103 | 1/8/2006 4:13 |
| 15598991 | HighID\|1175588707\|44AC9BA21F0E56244204B04358606FD6 | 70.18.15.99 | 1/9/2006 2:04 |
| 15609337 | LowID\|4528266\|93AAEB4DFC0E9D291B497BE5E09D6FCF | 70.106.160.128 | 1/9/2006 15:31 |
| 15611667 | HighID\|1175503724\|985809F19A0EBEB1B3D50E699FAF6F24 | 70.16.195.108 | 1/9/2006 16:22 |
| 15611951 | HighID\|1175588707\|44AC9BA21F0E56244204B04358606FD6 | 70.18.15.99 | 1/9/2006 16:22 |
| 15626866 | HighID\|1181328778\|A50C990A000EB314D033074B275D6F3F | 70.105.165.138 | 1/9/2006 22:10 |
| 15669524 | HighID\|1181692892\|2DAAEDEDE90E39FC86953D384A0C6F81 | 70.111.51.220 | 1/10/2006 13:27 |
| 15682259 | HighID\|1206921629\|C0AE4AC7560E05F6E875411A0ABA6FC2 | 71.240.41.157 | 1/10/2006 18:50 |
| 15701542 | HighID\|1181387640\|AC0D211F1D0E2FAB2124EC356BAC6FAE | 70.106.139.120 | 1/11/2006 6:31 |
| 15704608 | HighID\|1207028235\|FF598E57D20E0D2F37B8BB2B490B6F11 | 71.241.202.11 | 1/11/2006 8:09 |

tracking at the individual infringer level. Other forms of unique identification are within the scope of then invention.

In the sample data of Table A, each suspected data transfer in the swarm that is detected by the crawler is given an identification to distinguish the activity. In one example, a data exchange of a content piece between the crawler and a peer in the swarm can be uniquely identified. The user name refers to the identification of an individual user and can be, for example, a three part string separated by a “|”, wherein in this example, the first part of the three part string shows “HighID” or “LowID”; the second part of the string shows a numeric indicator associated with the activity; and the third part of the string identifies the peer participant in the swarm. For example, the same peer having a unique identifier “44AC9BA21FOE56244204B04358606FD6” is associated with two potential unauthorized distributions represented by identification 15598991 and 15611951.

The IP address is also obtained and although the IP address can be dynamic, the IP address 70.18.15.99 is the same for identification 15598991 and 15611951. This can be used to further substantiate the confidence level that the peer is accurately identified. The crawler participated with this peer on the specified date/time.

TABLE B

| Asset name | Filename | Filesize | % |
|---|---|---|---|
| Battlestar Galactica(TV) | Battlestar.Galactica.S02E10.Pegasus.DVDRip.XviD-TOPAZ(osloskop.net).avi | 367114240 | 28 |
| Wedding Date, The | The Wedding Date 2005 Xvid Ac3 Cd2-Waf.avi | 734849024 | 1 |
| 40 Year-Old Virgin, The | The.40.Year.Old.Virgin.2005.UNRATED.DVDRip.XvID-YUiZ.avi | 734404608 | 100 |
| Wedding Date, The | The Wedding Date 2005.avi | 732428288 | 100 |
| Wedding Date, The | The Wedding Date 2005 Xvid Ac3 Cdl-Ace.avi | 734791680 | 27 |
| Battlestar Galactica(TV) | Battlestar.Galactica.-.2003.-.S01E02.-.Water.(Wassermangel).avi | 366958592 | 100 |
| 40 Year-Old Virgin, The | The.40.Year.Old.Virgin.UNRATED.DVDRip.XviD.CD2-DiAMOND.ShareHeaven.avi | 731185152 | 100 |
| Airwolf(TV) | AirWolf-18-Sins of the Past.mpg | 514747408 | 88 |
| Serenity | Serenity-DivX-cd2.avi | 735160320 | 38 |
| Two for the Money | two.for.the.money.dvdrip.xvid-diamond-cdl.avi | 733153280 | 23 |

As noted in Table B, the digital asset is also identified by an asset name that in this example is the title of the work. In other example, the title can be modified or be identified by other keywords. This is particularly helpful if there are more than one work or movie with the same or similar title. The actual file name for the digital asset is also cataloged along with the size of the file. The percentage of the file that is held by the peer at the time of the communication with the crawler is also captured which would of course also indicate the amount of file remaining to be downloaded from the swarm. Such information is helpful to characterize the characteristics of the suspected unauthorized distributor. For example, a peer that tends to obtain the content quickly during the swarm may provide some indicia that the peer is a more robust P2P participant with greater P2P resources. A peer that seems to have a full copy may also provide some indicia that the peer is a seed and perhaps an origin seed for the unauthorized content. The various factors can be weighted into a confidence level determination that can be used to establish the most appropriate course of action to undertake.

In addition to gathering data of P2P activity by suspected unauthorized distributors, various embodiments also process characteristics, behavior, and/or traits of the various peer participants. Some of this knowledge may be used as part of an enforcement component. For example, various forms of notices and informational materials may be provided to certain distributors. In other instances, the ISPs may be informed of the suspected improper distribution and they may take appropriate measures. And, in other situations, legal actions may be undertaken.

With respect to one of the enforcement components, one embodiment of the present system provides for the dispatch of notices in conjunction with the processing and analytics detailed herein. By employing intelligence into the notification component, the most efficient processing can be employed to achieve the optimal results. By way of illustration of one example, Table C illustrates how such notification processing can be implemented in conjunction with the data of Table A and Table B.

TABLE C

| Status | Last activity | Notices | ISP | Server IP address | First Notice |
|---|---|---|---|---|---|
| 2 | 1/11/2006 6:13 | 1 | Verizon Internet Services | 80.239.200.108 | 1/12/2006 4:26 |
| 2 | 1/9/2006 2:04 | 1 | Verizon Internet Services | 195.245.244.243 | 1/12/2006 4:26 |
| 2 | 1/9/2006 15:31 | 1 | Verizon Internet Services | 199.249.181.16 | 1/12/2006 4:26 |
| 2 | 1/9/2006 16:22 | 1 | Verizon Internet Services | 80.239.200.102 | 1/12/2006 4:26 |
| 2 | 1/9/2006 16:22 | 1 | Verizon Internet Services | 195.245.244.243 | 1/12/2006 4:26 |
| 2 | 1/9/2006 22:10 | 1 | Verizon Internet Services | 195.245.244.243 | 1/12/2006 4:26 |
| 2 | 1/10/2006 13:27 | 1 | Verizon Internet Services | 195.245.244.243 | 1/12/2006 4:26 |
| 2 | 1/10/2006 18:50 | 1 | Verizon Internet Services | 82.80.248.24 | 1/12/2006 4:26 |
| 2 | 1/11/2006 6:31 | 1 | Verizon Internet Services | 195.245.244.243 | 1/12/2006 4:26 |
| 2 | 1/11/2006 8:09 | 1 | Verizon Internet Services | 83.149.123.189 | 1/12/2006 4:26 |

As shown in Table C, the peer identified as “44AC9BA21FOE56244204B04358606FD6” (associated with two potential unauthorized distributions represented by identification 15598991 and 15611951) represents numbers two and five on the list of ten samples. The initial activity was noted on Jan. 9, 2006 as shown in Table A for both activities. Based on continuous monitoring with the crawlers, this was also the last time any improper P2P activity was detected. There was one notice concerning the alleged unauthorized distribution on Jan. 12, 2006. Thus, in this particular example, based on the characteristics of the peer, it was determined that a notice was appropriate and a single notice appears to have successfully deterred future misuse.

It should be readily apparent that this is just a small sample set of only one particular application that is provided solely to illustrate the basic functionality. Some of the data fields that may be utilized in the system typically include an identifier to each activity detected by the crawler during the swarm participation at a particular time, such as: the user name that uniquely identifies a user, the IP address of the user, P2P protocol, number of crawlers in swarm, date/time when improper activity detected, name of the digital asset that was distributed, name of the file that was shared, size of the file shared, percent of the digital asset held by the user, approximation of user download bandwidth/speed, notification status, last reported improper activity, total number of improper actions, dates of all notices including notice type as well as addressees, any response from ISP or user, ISP of user, server IP address, and related data information

While there have been various attempts to address the Internet piracy problems, the main focus thus far has been related to technological attempts to thwart the piracy. While there have been some peer-to-peer network tracking and monitoring efforts, there has been little emphasis on piracy analytics.

According to one aspect, the system processing areas include at least some of the following: unauthorized distributor characterization and recidivism analysis; notice effectiveness quantification; randomized trial design and implementation framework. Further features may include unauthorized distribution trends and metrics design as well as visualization and presentation of the results. There are a number of variations and processing options that may depend upon factors such as the particulars of the network, the digital assets, the desired result and the technological capabilities.

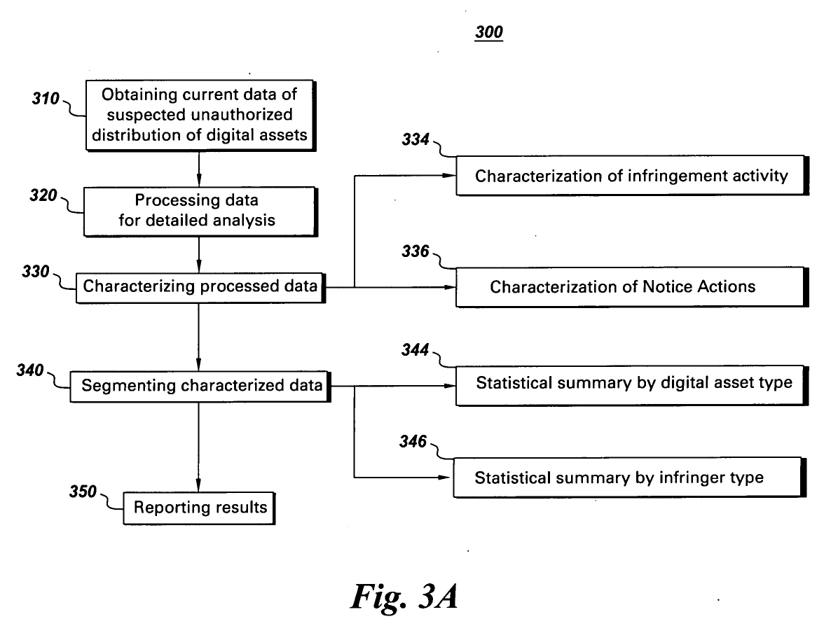

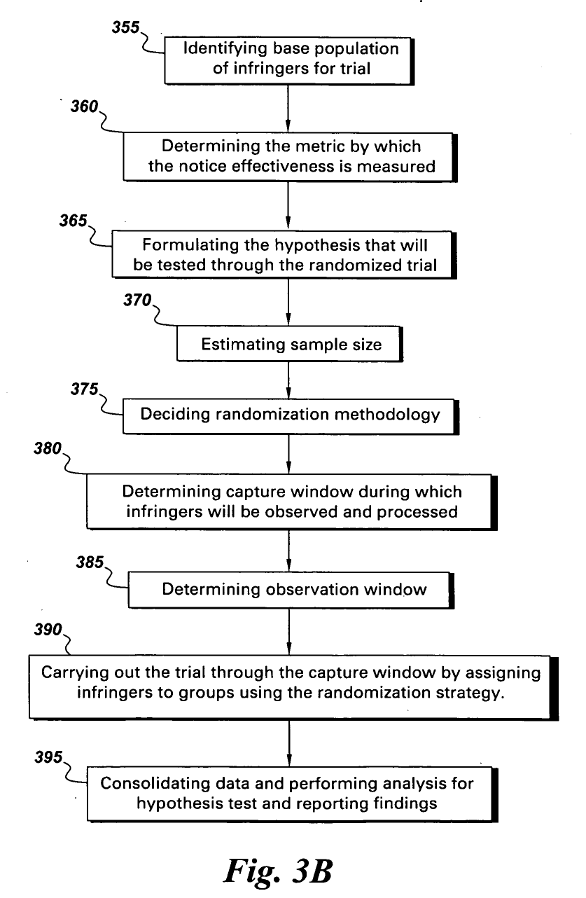

Referring to FIG. 3a, one embodiment for characterization processing 300 is depicted. The data from the P2P crawlers of suspected unauthorized distributors is collected 310 and contains various fields of data such as the user name, user IP address, P2P protocol, date/time of improper activity, name of the digital asset, file name, file size, percent of the digital asset held by the user, notification status, last reported improper activity, total number of improper actions, dates of all notices, user ISP, and server IP address. The data may also include other information such as number of crawlers, approximation of user download bandwidth/speed, as well as response data to the notices.

The data may include new data as well as certain historical data. If there is prior data, the new data fields can be compared to the prior data to ascertain whether there are any identifiable or other characteristics denoting similarities of unauthorized distributors. While one particular data field may not be able to accurately link an unauthorized distributor, several factors can be used to provide some degree of certainty. In one aspect, a weighting algorithm can be utilized wherein certain data fields are given a greater weight in ascertaining similarities.

By way of example, the P2P system may employ a hash that assigns a unique number for each client PC independent of the IP address. Even if a network device has multiple PCs, this unique identification number allows tracking to an individual user. It also can note the number of times a particular user participated in various swarms for certain content. There are other vendors with systems to uniquely track P2P users and this data can be used by the system detailed herein.

With respect to the other P2P systems that do not have a unique client tracking feature, it is sometimes more difficult to precisely calculate the number of unauthorized distributions or whether one party participated in multiple swarms. It also becomes more difficult to match the notices and their effectiveness. However there are other mechanisms to help identify a particular user as detailed herein.

The data is typically cleaned, processed and/or formatted 320 into a form that is more usable for the post processing. The formatting typically attempts to place the data in a usable format that allows for post processing since the data may arrive in various formats and from multiple sources. The sorting attempts to place the data to allow convenient post processing, such as placing data related to a particular swarm, a particular content file or a particular user. There are many different manners of sorting/filtering that can be used according to the design criteria to refine the amount of data to be processed.

The processed data is then subject to an overall characterization 330. used to segment data concerning the improper usage using one or more variables. The overall characterization in this example is divided into two sections, namely the characterization of infringement activity 334 and the characterization of notice action 336. This division of the overall characterization is for explanatory purposes and the characterization in certain embodiments can be based on one or more variables from at least one of the characterization of infringement activity 334 or the characterization of notice action 336.

The characterization of infringement activity 334 includes at least infringement rate, infringement count distribution, and statistical summary of infringement duration. Other attributes are within the scope and are those features that elicit some behavior, characteristic or trait that can be used to segment infringement. The activity data can be based on overall data or a segment thereof.

The characterization of the notice actions 336 includes at least notice sending rate, statistical summary of how promptly notices are sent after an infringement, and statistical summary of infringers stopping after notice. Other attributes are within the scope and are those features that elicit some behavior, characteristic or trait that can be used to segment infringement. The notice action data can be based on overall data or a segment thereof.

The characterized data is segmented thereby dividing the total population of data into smaller groupings according to the behavior, characteristics and/or traits. For illustrative purposes the segmenting is divided into categories according to the type of digital asset 344 and according to the infringer type 346. The category according to digital asset type such as television or movie includes at least one of statistical summary of infringement actions, infringement duration, notice actions. The digital assets include television, movies and other assets that are subject to P2P distribution. The category according to infringer type 346 such as one-time infringers, casual infringers, recidivist infringer includes at least one of statistical summary of infringement actions, infringement duration, and notice actions.

As noted, the unauthorized distributor categories are utilized to distinguish levels of unauthorized distributors, namely one-time peers, casual peers and recidivist peers. The category of the unauthorized distributor may depend upon a number of characteristics and/or behaviors that can be processed to define two or more groups. Other categories and levels are within the scope of the system.

Based on analysis of actual data gathered from the crawlers, it was noted that typically only a relatively small fraction of highly active peers account for a large portion of the unauthorized distribution. According to one sampling, about 43% of the unauthorized distribution by a particular peer was a one-time event. Furthermore, about 7% of the peers committed 50% of the unauthorized distribution. For convenience, three designated grouping are utilized, namely one time peers, casual peers and recidivist peers.

Based on actual data, the one time peers tend to make up about 50% of the unauthorized distributor population for both compliant ISPs as well as non-compliant ISPs. There are a number of factors that explain this majority population such as those that are curious and wish to experiment, completely unaware of the impropriety of the swarm participation. They may also be some that are looking for a particular digital asset at a particular time and would otherwise employ legitimate channels. In some instances, a timely notification or general awareness program to the one time group may be sufficient to eliminate this user from such future activities.

The casual peer population consists of peers that are involved with more than one unauthorized distribution, but are not highly active or otherwise have characteristics indicative of frequent unauthorized distribution. The casual peers constituted about 40% of the population of unauthorized distributors and are typically more likely to respond to a notice and countermeasure program.

Only about 10% of the peer population is highly active recidivist peers and accounted for about half of all the unauthorized distributions. This recidivist peer population tends to ignore the notices and generally represents the most difficult group to stop. However, by identifying this particular group, a focused program can be utilized with specific measures that optimize the efforts for reducing piracy.

Broadly speaking, recidivist peers are those that are involved in multiple unauthorized distributions of multiple assets and multiple instances. A recidivist is typically characterized by the frequency of unauthorized distribution, although other factors such as bandwidth, geographic location, type of P2P protocol or service, and manner of operation may provide indicia or characteristics attributable to a recidivist peer.

In one embodiment the unauthorized distributor characteristics for the one-time peers, casual peers, and the recidivist peers are based on a number of factors some of which may include: average number of unauthorized distributions; average number of unauthorized distributions days per unauthorized distributor; proportion of unauthorized distributors that account for half of the unauthorized distributions; proportion of unauthorized distributors with 3 or more unauthorized distributions; proportion of unauthorized distributors with 3 or more unauthorized distributions over a successive 3-day window; proportion of unauthorized distributors involved with only TV assets, only movie assets and both type of assets; and proportion of unauthorized distributors with 10% of a file, with 25% of the file with the whole of the file.

One aspect of the system and methods describes metrics to characterize unauthorized distributors to aid the content owners in understanding the different kinds of unauthorized distributors along with their activity levels and preferences. At an aggregate level this helps the content owners to understand the behavior of more seasoned pirates as opposed to amateurs. This in turn helps these content owners to formulate high-level strategies to combat such piracy in a more effective manner. At an individual ISP or P2P network level, this helps business to tailor their strategies specific to a network or ISP.

A further embodiment includes a categorization of the unauthorized distributor based upon various factors, which may include a weighting of certain factors that aid in the classifications.

There can be additional processing related to the response by the content owner and/or its agents which can also be based on various factors. Such processing can utilize response characteristics and behavioral characteristics in order to optimize the results of the anti-piracy efforts.

The results of the processing are reported 350 and can be displayed in a number of ways and implement a number of visualization tools to provide the end user with a clear presentation of the process and results.

One example of behavior relates to the type of asset subject to the unauthorized distribution. The types of assets provide some indicia of the behavior since certain assets are more commonly misappropriated. In one example, assets were categorized according to movie titles, television titles and combinations of movies and television titles.

In one embodiment the results involve comparison of various ISPs with respect to key metrics on factors such as infringement activity, infringement duration, notice actions, and effectiveness of notices in stopping further infringing activity. The ISPs can utilize such information for business decisions. The results can indicate, for example, individual parties or groups of parties that present the bulk of the unauthorized distribution and take action accordingly. Such focused actions saves considerable costs and resources.

The characterization and recidivism analysis of the unauthorized distributors according to one embodiment has features that include the characterization of the overall unauthorized distribution activity through metrics. Some of the metrics may include at least one of the following: total number of unauthorized distributions; total number of unauthorized distributors (identified by unique user id); frequency distribution of number of unauthorized distribution days of an unauthorized distributor; frequency distribution of unauthorized distribution activity duration (last date-first date on which the unauthorized distributor was seen); and frequency distribution of time between two successive unauthorized distributions.

Referring to FIG. 3b, a process flow for a randomized trial is depicted which can be used to provide an objective measure of the notice effectiveness. This segment of the processing commences with identifying a base population of infringers for the trial 355. The base population can be defined according to the design criteria and specifically tailored or it can be more generically based. In one embodiment the base population is pre-defined and relatively static. Alternatively, the parameters of the based population can also be dynamically adjusted in a further embodiment. A graphical user interface (GUI) can be utilized to provide the dynamic adjustments.

There are certain metrics used to measure effectiveness of the notices and the metrics are chosen based upon the manner in which the notice effectiveness will be measured 360. As an example of the metrics of the notice effectiveness, the notice sending metric can be a percentage of first notices that were sent following the first day of the unauthorized distribution. Some examples of the unauthorized distributors response metrics include such aspects as the percentage of one day unauthorized distributors in the ISP unauthorized distributor population, percentage of unauthorized distributors not seen after first notice, percentage of 3+ day unauthorized distributors in the ISP unauthorized distributor population, Average number of unauthorized distributions per unauthorized distributor.

The system in this example formulates hypothesis used for testing during the randomized trial 365. In order to facilitate processing, the sample size is estimated 370. The sample sizes can be determined through simulation.

One example of a simulation study is as follows: a) Fix sample sizes: n₁=size of Control (No notice) group; n₂=size of Treatment (Notice) group. b) Set up a grid of (θ_{C}, θ_{T}) wherein in one case the grid is 30%-70% in steps of 5% for both θ_{C} and θ_{T}. c) For a particular point in the grid (for example (θ_{C}=60%, θ_{T}=45%) perform single trial processing. In a single trial, processing randomly selects x1 from Binomial (n₁, θ_{C}) and x₂ from Binomial (n₂, θ_{T}); calculates pc=x₁/n₁, p_{T}=x₂/n₂, p=(x₁+x₂)/(n₁+n₂); and computes and saves the value of z.

According to one experiment, a single trial is repeated many times and compute r=% is times (z>1.65), wherein r is the power of the test at (θ_{C}, θ_{T}) for sample size (n₁, n₂). Fixing (n₁, n₂) and varying (θ_{C}, θ_{T}) over the grid the Power Surface is obtained. A contour plot of the Power surface is generated and the plot power surfaces are further developed by varying (n₁, n₂)

The randomization methodology is selected 375. By way of illustration, the unauthorized distributors are assigned to groups and a random assignment is used to allocate the groupings. For example, a random number can be designated between 0 and 1 from a uniform distribution and the groupings can be a notice group and a no-notice group. If the random number is less than 0.5 the subject is assigned to the notice treatment group, otherwise the unauthorized distributor is placed on the no notice treatment group.

A capture window is determined with a starting point and an ending point during which the activity will be observed and processed 380. The window can be a time period such as a number of days or it can be tied to other factors such as a number of counted activities. The observation window is also determined 385.

The randomized trial is conducted through the capture window 390. In one embodiment the suspected infringers are categorized into groupings such as notice groups and no-notice groups.

Depending upon the category of the unauthorized distributor, some response is promulgated 350. The type of response may vary depending upon the category of the unauthorized distributor, which may include one or more of the following: no notification, an email message, a telephone message, a general informational mailing, a notice letter to the unauthorized distributor, a notice letter to the ISP, a cease and desist letter, a complaint. The communications or messages can include various mechanisms and offers to resolve the unauthorized distribution issue such as purchase options for the digital assets and agreements with settlement terms. As should be readily apparent, the content owner or agency seeking enforcement against piracy prefers to handle unauthorized distribution in a simple manner.

One example of a response is the promulgation of one or more notice letters to certain types of distributors. This can include an initial notice letter with one style and format as well as additional notices having other styles and formats. The notice letters can be sent to the suspected unauthorized distributor and/or the ISP. In one embodiment, the process is automated, at least to some degree, such that the notices are easily dispatched. Tracking information related to the notices is stored in the database and includes the date of transmission, the manner of transmission, and the addressee.

In one embodiment, the notice letter is sent only to the ISP of the unauthorized distributor along with details concerning the identification of the distributor and the improper usage details. Depending upon the compliance level of the ISP, a notice communication may be sent from the ISP to the ISP customer that is identified as the unauthorized distributor. According to certain legislation, the ISP may be able to incur certain safe harbor provisions against legal actions commenced by the content owner or its agents by working with the content owner on addressing the piracy. Thus, the ISP has an incentive to abide by the legislative requirements to obtain the safe harbor provisions and process the notices.

While one embodiment provides a system and method for assessing the effectiveness of cease-and-desist notices sent to P2P infringers, the same technology also is applicable to other circumstances, such as a comparison of any treatment of interest in a P2P piracy framework. One example includes tests to convert piracy users to legitimate users such as by referring some percentage (e.g.: 50%) of the group to a legitimate site. Another example involves tests to measures the effectiveness of countermeasure methods (e.g.: decoys, interdiction), and testing the effect of the language used in the notice letter.

Likewise, even though certain description were limited to two levels of a single treatment, for example, notice versus no notice, the approach detailed herein can be used in situations involving multiple levels of multiple factors, for example, user piracy history (low, medium, high) and notice language (mild, harsh, harsher).

Notice effectiveness quantification can include a number of criteria and processing attributes. Various criteria are used in the analysis that includes metrics for measuring the notice effort. Such metrics for measuring notice efforts may include: proportion of unauthorized distribution that received notice; proportion of unauthorized distributors who received at least one notice; and proportion of unauthorized distributors who received a notice immediately after their first unauthorized distribution.

The processing continues with consolidating the data output, analyzing the hypothesis testing, and reporting the findings 395.

A further processing feature is the response effectiveness quantification. The efficiency and effectiveness of the system depends at least to some extent on the response. There are numerous aspects that can be considered in quantifying response effectiveness and in some cases it is not solely a measure of stopping the highest number of unauthorized distributors. For example, the strategy for mitigating unauthorized distribution of a particular movie asset is different than that employed for a television asset. Furthermore, the content owner may have strategic plans to focus on a particular problem area that may involve primarily recidivist peers using non-compliant ISPs, which is likely to have a lower percentage of stopping the number of peers but might actually lower the number of unauthorized distributions.

Characterization statistics were conducted for several major U.S. and foreign ISPs. The ISP identification is not relevant to the systems and methods herein, and the naming is merely to distinguish the ISPs and illustrate the type of activity provided by such reports.

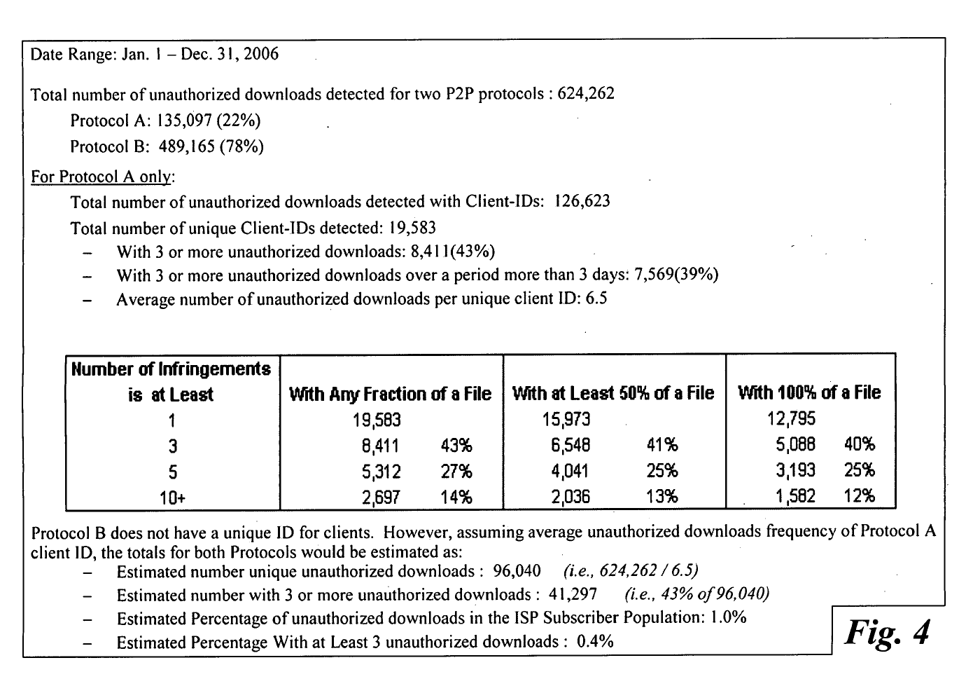

Referring to FIG. 4, an illustrative examples of metrics used to characterize a major U.S. ISP is shown. This illustrates the type of activities and the results of some of the analysis. The data was processed for a particular ISP for the time frame of Jan. 1, 2006 through Dec. 31, 2006. During this time period, there were almost 625,000 suspected unauthorized distributions for this single ISP for the two P2P protocols that were being evaluated. This amply demonstrates the prolific nature of the unauthorized distribution problem. For the two protocols under evaluation, P2P Network A and P2P Network B, the majority of the problem downloads were conducted for Network B.

In this particular example, protocol A was subject to processing according to one embodiment of system and the subsequent analysis. The protocol A employed some form of client identification, and out of the 135,097 detected unauthorized distributions, 126,623 (approximately 94%) were identified using the client identification. This data supports the implementation of some form of protocol client identification to aid in identifying such unauthorized distribution.

Out of the protocol A unauthorized distributions, there were almost 20,000 unique client IDs that were responsible for the 126,623 downloads. Furthermore, 43% of the unique client IDs had three or more downloads. The average number of unauthorized downloads re unique client ID was about 6.5.

Using this characterization, information about other protocols and ISPs can be extrapolated to provide a representation of the P2P unauthorized distribution dilemma. In addition, effective means for preventing such distribution can be implemented and deployed using the data.

A general characterization of the unauthorized distribution population is illustrated in Table D reflecting the outcome of the processing. This data was based on data from 2006 for certain digital assets detected by a third party crawler based on a select number of US ISPs. This processed data indicates certain characteristics and behavior that is implemented into effective counter-measure systems. A relatively small number (7%) of the peers, namely recidivist peers, account for almost 50% of the unauthorized distributions. Approximately 43% are characterized as the one-time peers. The remaining peers are identified as casual peers with associated traits as detailed herein.

TABLE D

| Unauthorized Distribution Behavior | Overall | Range by ISP |
|---|---|---|
| Average Number of unauthorized | 7 | 3-9 |
| distributions per peer | | |
| % of unauthorized distributors only active | 43% | 4-14% |
| 1 day | | |
| % of unauthorized distributors that account | 7% | 40-53% |
| for half of the unauthorized distributions | | |
| Maximum elapsed days for 95% of | 187 days | 30-282 days |
| unauthorized distributions | | |

Another classification for the behavior is based on the type of digital asset subject to the unauthorized distribution is illustrated in Table E. This data shows that about 90% of the unauthorized distributions are based exclusively on movie downloads or exclusively on television downloads. It is generally understood that the movie downloads are subject to a greater scrutiny, and it is evident that this represents a more prominent issue.

TABLE E

| Unauthorized Distributions | TV | Movie |
|---|---|---|
| Average Number of unauthorized distributions per peer | 38% | 62% |
| % of unauthorized distributions that are active one day | 17% | 72% |
| only | | |
| Average number of unauthorized distributions for | 15 | 6 |
| each peer | | |

A further classification refers to the traits of the unauthorized distributor as another feature useful in categorization. For example, the recidivist peer is an active participant in unauthorized distributions that downloads many digital assets and is active in many downloads. This recidivist peer tends to download multiple copies of the same digital asset, obtaining copies in different formats as well as with differing quality such as resolution. It is also common that such a peer is simultaneously active in a number of downloads of the same digital asset to increase the likelihood of obtaining a quality copy faster. Furthermore, this behavior increases when countermeasure programs that generate ‘bogus’ versions of the digital asset are deployed.

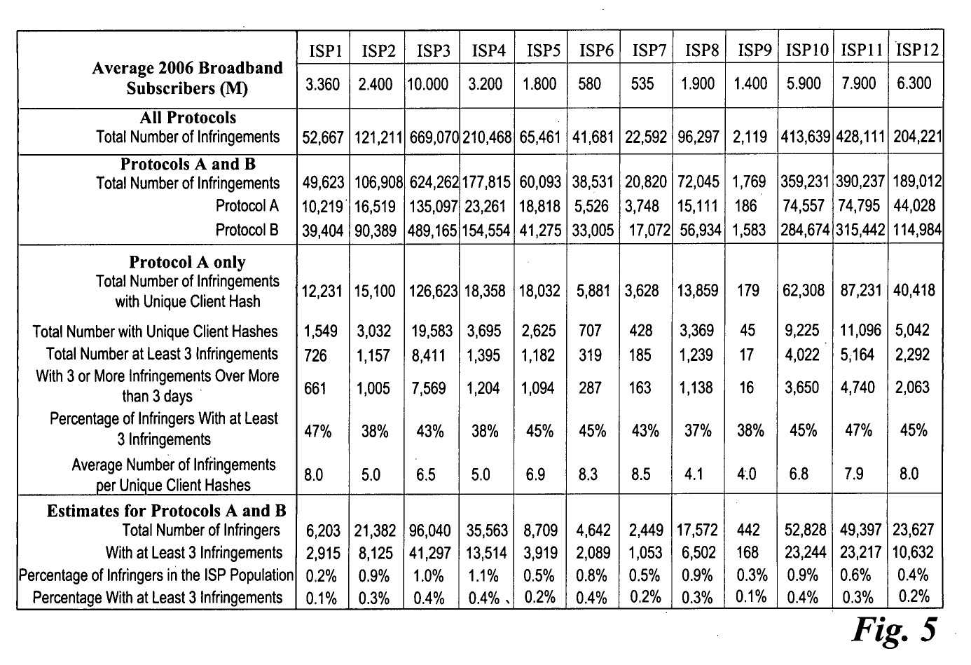

As yet a further example associated with the characterization of the unauthorized distributor peers for improper content, FIG. 5 shows data from 2006 involving twelve US ISPs and in particular the unauthorized distribution associated with two protocols, namely Protocol A and Protocol B. As used in this figure, the use of the term infringement is equated with unauthorized distribution.

The subscriber base of the ISPs ranged from 140,000 to 10,000,000 representing a significant subscriber population. The unauthorized distributions for all protocols varied significantly among the ISPs, and ranged from 2,119 to 699,007, while the percentage of unauthorized distributors as compared to number of subscribers also varied. For example, ISP 10 with a subscriber base of almost six million had about 413,639 unauthorized distributions, wherein ISP 12 having over six million subscribers had only 204,211 unauthorized distributions. The ISP represents another feature for analysis as some ISPs have a reputation of being more tolerant of unauthorized distributions whereas some ISPs are known to be more compliant with the regulations governing dissemination of improper content.

The Protocols A and B were further analyzed, wherein Protocol A employed a client identification that made the processing simpler by uniquely identifying the party involved in the distribution. The combination of these two protocols represented a vast majority of the overall unauthorized distributions. As noted for Protocol A, certain characteristics were examined such as the total number of unauthorized distributions with the unique client hash, total number of unique client hashes, total number of at least three unauthorized distributions, three or more unauthorized distributions over more than three days, percent of unauthorized distributors with at least three unauthorized distributions, average number of unauthorized distributions per unique client identification. As noted, on average over 40% of these unauthorized distributions were from those uniquely identified peers involved with at least three unauthorized distributions.

According to one embodiment, the data from the analysis of the protocol providing a unique client identification allows for extrapolation to other protocols to provide accurate estimates for the combined Protocol A and Protocol B

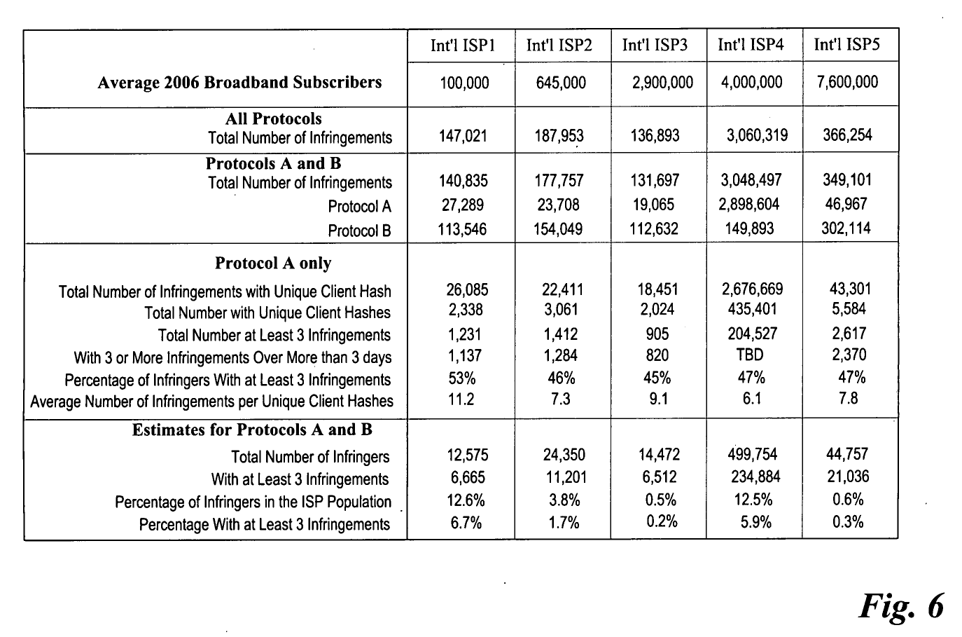

While most of the discussions have involved US ISPs, FIG. 6 illustrates that the international ISPs follow a similar pattern in certain respects to the unauthorized distributions. It also shows some of the differences and illustrates that the unauthorized distribution problem can be even a greater problem among certain international ISPs with ISP 4 having over three million unauthorized distributions among only four million subscribers. Furthermore, the proportion of users with three or more infringements was higher (45%-53%) in non-US ISPs compared to US ISPs (37%-47%). As noted herein, some of the ISPs may be more compliant or otherwise stricter with respect to unauthorized distribution problems.

According to one embodiment, the present system not only provides for a classification scheme for the unauthorized distribution and the unauthorized distributors, but also illustrates a mechanism for countering the problem. Using the analysis detailed herein and formulating a classification scheme, a notice program was implemented that provides for a more efficient manner of implementing the notice program for optimal results.

By way of illustration, referring to Table F, a corresponding notice program is depicted using the same data set as set forth in Table D. A portion of the unauthorized distributors was issued notices, wherein the percentage ISPs issued a notice ranged from 15%-34%. As noted, an average of 45% of the unauthorized distributors were one-time peers that ceased after a first notice. The notice process can be optimized as detailed herein to incorporate the notice results with the classification and optimize the system for optimal performance.

TABLE F

| Unauthorized Distribution Behavior | Overall | Range by ISP |
|---|---|---|
| % of Infringers served a notice | 27% | 15-34% |
| Number of notices per unauthorized distributor | 0.90 | 0.3-1.6 |
| % of 1^{st} notices sent after 1^{st} day of | 42% | 33-56% |
| unauthorized distribution | | |
| % of unauthorized distributors not seen after 1^{st} | 45% | 34-83% |
| notice | | |

Another notice effectiveness quantification criteria can include metrics for measuring notice effectiveness. The metrics for measuring notice effectiveness may include: proportion of unauthorized distributors who were active only one day; and proportion of unauthorized distributors who were active on 3 or more days.

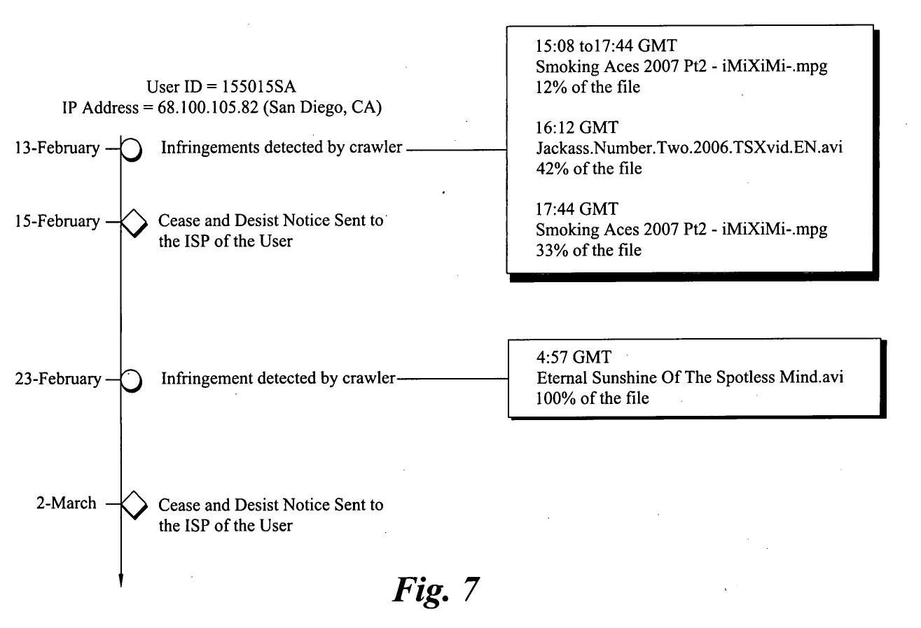

For illustrative purposes, an example of a notice program for a single identified user is shown in FIG. 7. In this example, the protocol used for the download provides for unique client identification, namely the User ID. In this particular case, the IP address was also collected along with other data as detailed herein. The crawler participates in the P2P swarm acting like any other peer in obtaining the content files. In this particular case, the crawler is monitoring a number of digital assets which includes the movies entitles Smoking Aces 2007 Pt 2 and Jackass Number Two. These may be the actual titles or some variation of the title such as keywords. The crawler has a pre-existing list of such title and keywords that it uses to search for copyrighted content. The list changes over time and may reflect information from the content owner. As noted, on Feb. 13, the unique user was involved in downloading two digital assets including different versions of the same asset.

On Feb. 15, notices were sent out the ISP of the user. As detailed herein, there are compliant and non-compliant ISPs in the industry. Compliant ISPs follow-through from the notice and will notify the user of the complaint in order to obtain the safe harbor provisions under the DCMA. Other ISPs are less complaint and may not take action even though this may invite liability concerns. At some point, the courts may impose harsh penalties on the non-compliant ISPs thereby minimizing the number of non-complaint ISPs.

Additional unauthorized distributions by this unique User ID were detected on Feb. 23 involving another digital asset subject to protection. On March 2, another letter was sent to the ISP if the user. The response, or lack thereof, will be recorded in the subsequent processing that may be used in subsequent decision-making determinations. For example, based on the ineffectiveness of the notices, additional measures may be taken.

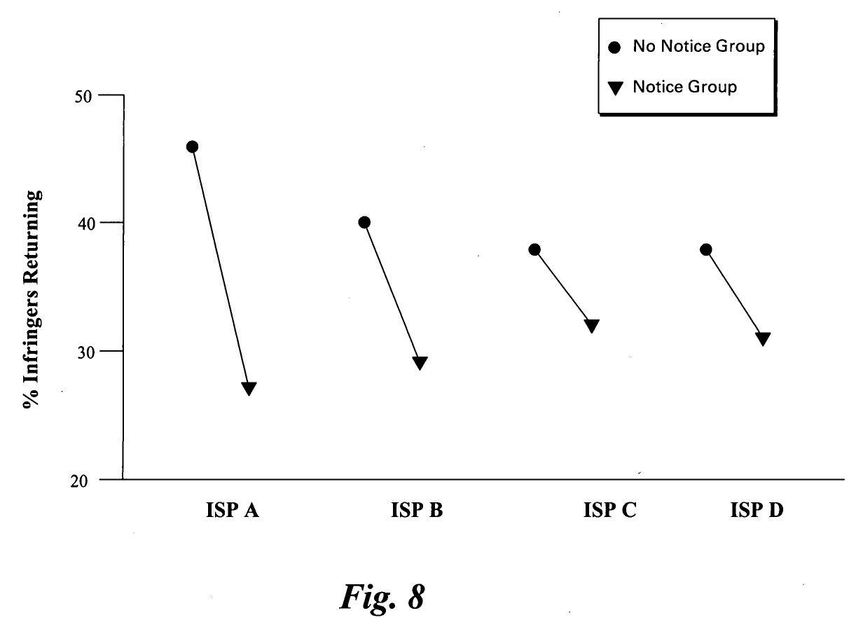

The effectiveness of the notice program according to one embodiment is visually shown in FIG. 8 for several ISPs to show the percentage of infringers that continue infringing. These results were generated through a randomized trial.

The no notice group of unauthorized distributors is significantly higher across all the ISPS ranging from about 37% to 46% of repeat unauthorized distributors. In contrast, the number of repeat infringers across the four ISPs was much lower under the notice program, with the percentage of unauthorized distributors ranging from about 27%-32%. The use of visualization tools to more clearly display the results is a further feature of the system.

The notice processing according to one embodiment is based upon establishing a capture window during which the crawler(s) participate in the various P2P activities and log the data that is used for the unauthorized distribution processing. The window needs to be of sufficient time to extract enough of the P2P population in order to effectively use the data. The dynamics are such that the window may vary significantly from a number of hours to a number of days or even weeks depending upon various factors. Following the capture window is an observation window that is used to record the responses following the notice dispatch to the ISPs and/or the unauthorized distributors. The observation window is typically longer than the capture window. One observation example is for the crawlers to participate in the P2P activities and log data that may indicate further unauthorized distributions of a particular peer. The observation can also include response received from the ISP and/or the peer that can be used in subsequent processing.

It should be readily apparent that effectiveness quantification helps businesses to accurately measure the benefits from the respective notice programs. Comparing the benefits of the notice processes against the cost enables the business to calculate the returns on investment and help them make more informed decisions. This is particularly relevant when there are many factors to take into account and the systems require a mechanism to establish and quantify the cause and effect relationships between notices and a reduction in the unauthorized distributors/unauthorized distributions. Appropriate designs and frameworks are used to allow a proper measurement.

As an example of the problem of measuring effectiveness, comparing notice effectiveness measures between notice and no-notice group within an ISP is problematic. This is because the notices are generally not sent randomly to the unauthorized distributors but are guided by various business policies. For example, unauthorized distributors who stay active for a longer duration have higher chance of receiving notices. Hence the effect of notice gets confounded with many other factors.

There infringers were randomly assigned to notice (Treatment) and no-notice (Control) group. By this random assignment the two groups are identical in all respects other than receiving notice. The various notice effectiveness metrics (e.g. whether the infringer came back after receiving notice) was observed for the two groups and analyzed as to whether there were statistically significant differences between the two groups.

To measure notice effectiveness more accurately, a randomized trial was implemented. The randomized trial included a unique design features, design of a test statistic, sample size determination through the power-study simulation experiment (as opposed to a closed-form formula that has asymptotic normality assumptions), deciding the length of observation window by computing empirical distributions of time to second infringement, and deciding the length of the data-capture window for the randomized trial.

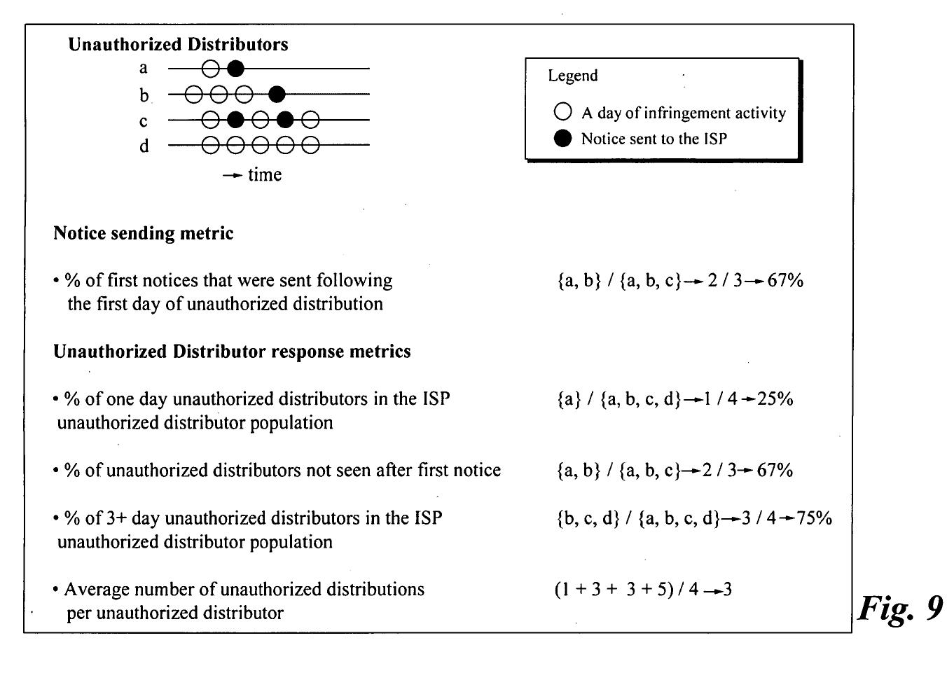

Referring to FIG. 9, an example of the notice effectiveness is depicted using example data for a fictitious ISP with four unauthorized distributors a, b, c, d. This illustrates one form of processing for notice effectiveness but it should be readily apparent that there are other processing techniques that can be used to establish notice effectiveness. In this example, the notice sending metric is based on the percentage of first notices that were sent following the first day of an unauthorized distribution.

The basic approach is to make ISP level comparisons based on notices served and infringement frequencies. The comparisons are based on the premise that for an effective notice program, one would expect decrease in infringement frequencies as higher fractions of infringers receive notices shortly after their first infringing activity. Two sets of metrics were constructed. A notice sending metric was used to characterize the timeliness and relative volume of notices dispatched to each ISP, and an unauthorized distributor metric was used to characterize the unauthorized distribution frequency by ISP.

The expected response to the early notice in an effective notice program would generally show an increase in the percentage of one day unauthorized distributors in the ISP unauthorized distributor population and an increase in the percentage of unauthorized distributors that are no longer found after the first notice. There should also be a decrease in the percentage of three-plus day unauthorized distributors in the ISP unauthorized distributor population. Furthermore, the average number of unauthorized distributions per unauthorized distributor should also decrease. This forecasting capability provides the information to content owners to employ strategic planning.

According to one embodiment, the method used for counting infringements was re-defined. It is quite typical that an individual infringer commits multiple infringements on a single day, thus the metric was redefined based on the number of days on which the infringer was active instead of the number of infringements. In one embodiment the total number of active days is reported instead of total number of infringements. Based on subsequent processing using actual data, it was demonstrated that the infringing rates decrease as fraction of notices sent early increase.

In accordance with one embodiment, a framework using a randomized trial was utilized to validate the effectiveness of the notices. The unauthorized distributors were randomly assigned to two groups, namely; a notice group, which receives the notice treatment (also called a test group); and the no-notice group where no treatment is applied (also called a control group). The groups were then observed for an observation-period and the difference in infringement. As previously indicated, there was a window to capture the data related to the P2P network activities having a start and stop point. There was also a window for noting the effects of any notices that were dispatched. A sufficient number of unauthorized distributors were part of the framework considerations in both groups.

The base population was the population of first-time unauthorized distributors or new unauthorized distributors on the network. A new unauthorized distributor was an unauthorized distributor who has had no prior history of unauthorized distribution activity. A new unauthorized distributor on a notice treatment would hence see a notice for the first time.

While other base populations are possible, such as sampling from the entire population, including ‘non first-time’ unauthorized distributors in both the test and control groups increases the heterogeneity of each group. An older unauthorized distributor might react very different from another older unauthorized distributor depending upon variables such as the historical data related to frequently of unauthorized distributions, length of time involved in unauthorized distributions, and number of notices received. However, a first-timer tends to react statistically similarly to another first-timer since they do not have any past history of unauthorized distribution activity. In addition, the data was arranged according to ISP, as each ISP employed different processing regarding the notice process and general compliance.

The response metric was established to measure the extent of the unauthorized distribution in a population. In more particular detail, the response metric, sample estimates and hypothesis were defined as:

The formulation of the hypotheses and statistical planning according to one embodiment includes power studies and sample size plans based on standard statistical approaches. For illustrative purposes, specifics as to the statistical planning are provided. Response metric states the following: θc=Probability that an unauthorized distributor in the control group (no-notice) will stop after his first unauthorized distribution; and θ_{T}=Probability that an unauthorized distributor in the test group (notice) will stop after his first unauthorized distribution.

Sample or point estimates of the metric are defined as follows: If x₁ unauthorized distributor out of n₁ unauthorized distributor stop after 1^{st} unauthorized distribution in the control group and x₂ out of n₂ unauthorized distributor in the stop after 1^{st} unauthorized distribution in the test group then the point estimates of the response metric are: pc=x₁/n₁=proportion in control group stopping after 1^{st} unauthorized distribution; and p_{T}=x₂/n₂=proportion in test group stopping after 1^{st} unauthorized distribution.

Hypotheses is stated as: Null Hypothesis: H_{0:} θc=θ_{T}—Probability of stopping is the same for groups i.e., the notice program does not have an effect; and Alternate Hypothesis: H_{a:} θc<θ_{T}—Probability of stopping is higher for the treatment (notice) group.

A simulation-based study was used to calculate the power of the test as a function of varying sample sizes. The statistical test of the hypotheses was based on the comparison of the sample estimates of probability of stopping from the two groups (pc and p_{T}). The hypothesis utilized states that:

$$z = \frac{{p}_{c} - {p}_{T}}{\sqrt{p ( 1 - p ) ( \frac{1}{{n}_{1}} + \frac{1}{{n}_{2}} )}} where p = ( {x}_{1} + {x}_{2} ) / ( {n}_{1} + {n}_{2} )$$

with the decision to reject H₀ in favor of Hₐ if z>1.65 (corresponding to α of 95%)

The sample size determination for the test and control groups was established through simulation in accordance with one embodiment. The simulation steps included the following: Fix sample sizes, namely n1=size of Control (No notice) group and n2=size of Treatment (Notice) group. A grid was established for (θ c, θ T), wherein the grid was 30%-70% in steps of 5% for both θ c and θ T.

For a particular point in the grid (e.g: θ c=60%, θ T=45%) the following single trial was conducted: x1 was randomly selected from Binomial (n1, θ c) and x2 from Binomial (n2, θ T). The following calculation were performed, pc=x1/n1, pT=x2/n2, p=(x1+x2)/(n1+n2). The z value was computed and saved.

The experiment for the single trial was repeated many times, such as 1000 times, and the value of r was computed: r=% times (z>1.65), wherein r is the power of the test at (θ c, θ T) for sample size (n1, n2). By fixing (n1, n2) and varying (θ c, θ T) over the grid the Power Surface is obtained. The contour plot of the Power surface was generated and the plot power surfaces were generated by varying (n1, n2).

The historical estimates of the difference between the true probability of stopping between the notice and no-notice groups was about 20%. Hence, with δ=20% for a power of 90% a sample size of 100 unauthorized distributors for the notice group and 100 for the no-notice group was established. These simulations indicated a sample 100 unauthorized distributors in each group (control and treatment) would provide adequate power to detect a difference of at least 10% in probability of stopping.

For the case where the sample size to be calculated is the same for the two groups of interest, a closed formula can be used such as:

$$n = {[ {z}_{α} \sqrt{\frac{( {p}_{1} + {p}_{2} ) ( {q}_{1} + {q}_{2} )}{2}} + {z}_{β} \sqrt{{p}_{1} {q}_{1} + {p}_{2} {q}_{2}} ]}^{2} / {d}^{2}$$

Two other aspects included the length of the capture window and the length of the observation window. In this example, the length of the capture window was selected according to the sample sizes and the daily arrival rate of the new infringers. Even though a sample size of 100 for the test and control groups for all the ISPs was desired, the arrival rate varied from one ISP to another. Hence the capture window for each ISP was different.

The observation window is the time the subjects are monitored or observed. This window should be long enough to allow an infringer to come back (if he chooses to come back). However there is no need to have the window excessively long as there is diminished returns. Therefore, according to one embodiment the window like should be appropriate for the implementation and resume normal operations of notice-sending to all the subjects in the experiment.

To decide the time that it takes for an infringer to come back, historical data is analyzed. A sample set of new infringers is identified on a random ISP and the empirical cumulative distribution function of the variable is computed for the time to the second or subsequent infringement. As noted in the figures, about 90% of the infringers return within 60 days for the repeat infringers and for one embodiment the length of the observation window was set to be at least 60 days.

With respect to data capture, the notice-sending program was turned off during the entire capture window. At the end of the capture window, the list of users (on the notice and no-notice program) was processed and the notice sending operations were resumed except for the subjects on the no-notice program.

The present systems provide for accurate measurements of P2P notification of unauthorized distribution to illustrate program effectiveness. As is well known, incorrect measurement methods often lead to misleading results and any decision based on such results are bound to be ineffective at best and possibly detrimental.

The unauthorized distribution metrics trends and metrics design provides for numerous manipulations for resolving present problems and also forecasting to address future concerns. Analysis of the trends tends to produce data capturing biases, and such biases can be estimated and corrected to generate the true underlying trends that emerge from the raw data.

According to one embodiment, certain features may include: application of capture-recapture methodologies (used in estimation of animal populations in the wild); and modeling that incorporates the effects of external factors such as number of crawler servers, level of resources at crawlers, filtering criteria, and movie ratings.

Raw trends calculated from the observed data often have pitfalls and hidden biases due to data capture methodology such as allocation of different amount of resources at different times leads to underreporting of key metrics. Corrections to normalize the effect of such spurious factors that are unrelated to the distribution are useful in understanding the “true” trends.

The specialized processing detailed herein can be integrated with a number of visualization tools to enable businesses to conduct thorough evaluations. For example, there are various plots incorporating notice benefit metrics versus notice effort metrics. For example, manipulating the data with a visualization tool helps to show relative ordering/ranking of ISPs in terms of their compliance levels.

Another aspect is the ability to view the data in different ways. For example, tracking of particular assets over time also allows for business strategies to provide protection policies specific to the asset. In one example, if a particular movie is going to launch that is known to be the type of asset that will be subject to unauthorized distribution, various pre-planning activities can be undertaken. Known movie infringers can be targeted and actions commenced according to the classification of the peer. Recidivist peers can be targeted with one set of measures while one-time peers and casual peers can each have different forms of responsive measures.

The tracking of infringement and notice history over time, including the response behavior for an individual infringer, enables the content owner and its affiliates to augment the understanding and preferences of the various peers and to extrapolate from such data to predict future trends and behavior.

According to one aspect of the invention, clear visual representation of the key metrics and results of analysis makes it easier to spot emerging trends, data errors, and outliers. Such reports presented in a form of periodic dashboards can help business in status-tracking, initiating further investigations, modifying existing policies and adopting new policies.

One feature of the system is that it introduces to the industry a set of methods and tools to better understand Internet piracy. One aspect provides a standard toolkit for content providers and content owners to manage anti-piracy programs.

Actual data from a series of experiments on unauthorized distribution on copyrighted digital assets have been used to confirm the approaches and methodologies. Certain data detailed herein is based on the actual data for illustrative purposes, however the names of the parties have been changed as they are unnecessary in showing the effectiveness of the present systems and processes.

There are a number of techniques for reading, processing, analyzing the data, generating text reports as well as graphical charts, designing and tracking randomized trials using the data gathered by the system and described techniques.

According to one embodiment, dashboards can be utilized to provide a more useful user interface to track the P2P distribution activity. Dashboards can be used for several purposes including tracking the extent of recidivism, monitoring the effort level of various company programs in addressing piracy, monitoring the benefit of the various company programs in addressing piracy, understanding the emerging trends of popularity of various P2P networks in terms of committing piracy, comparing various ISPs to understand their compliance level, and verifying the claims of ISPs about their own compliance level.

The systems and methodologies detailed herein can be used internally by content owners/providers, as well as by third party service providers as an aid to their various piracy strategy decisions. Some parts of the processing can be automated and incorporate various software tools according to design criteria. The systems and processes herein can also be integrated with existing systems and user interfaces. Certain components can be offered to other interested parties such as ISPs as well as enforcement agencies such as the Motion Picture Association of America (MPAA). The methodologies described herein provide anti-piracy service offerings that are more effective and efficient.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for dealing with unauthorized distributors of content on a peer-to-peer network, comprising:
processing data from a plurality of peers, and identifying an individual unauthorized distributor;
characterizing said data to produce characterized data;
segmenting said characterized data into groupings according to one or more variables; and
reporting results of said segmenting.

2. The method of claim 1, wherein said characterizing is based on overall data from at least one of characterization of unauthorized distribution activity and characterization of notice actions.

3. The method according to claim 1, wherein said variables comprises at least one of statistical summary of unauthorized distribution actions by digital asset type, infringement duration by digital asset type, notice actions by digital asset type, statistical summary of unauthorized distribution actions by unauthorized distributor type, infringement duration by unauthorized distributor type, and notice actions by unauthorized distributor type.

4. The method according to claim 1, wherein said reporting is a comparison of at least one Internet Service Provider (ISP) with respect to metrics on at least one of unauthorized distribution activity, unauthorized distribution duration, notice actions, and effectiveness of notice actions.

5. The method according to claim 1, wherein said segmenting comprises performing statistical analysis.

6. The method according to claim 1, wherein said data is obtained from one or more crawlers or from a third party source.

7. The method according to claim 1, further comprising assessing notice effectiveness.

8. The method according to claim 7, wherein said notice effectiveness comprises:
creating a trial with a trial base population of said unauthorized distributors and a trial capture window for the trial;
determining metrics for measuring said effectiveness; and
performing said trial with said trial base population over the trial capture window.

9. The method according to claim 8, further comprising selecting a randomization methodology for said trial.

10. The method according to claim 9, wherein said randomization methodology is a grouping of said unauthorized distributors into at least two groups, said groups comprising a notice group and a no-notice group.

11. A method for assessing notice effectiveness of unauthorized distributors of content on a peer-to-peer network, comprising:
processing peer data from a plurality of peers on said network, wherein said peer data aids in identification of individual unauthorized distributors;
creating a trial with a trial base population of said unauthorized distributors and a trial capture window for the trial;
determining metrics for measuring said notice effectiveness;
selecting a randomization methodology for said trial;
performing said trial with said trial base population over the trial capture window according to said randomization methodology and issuing notices to some of said unauthorized distributors;
characterizing said unauthorized distributors into characterized data of at least one of characterization of unauthorized distribution activity and characterization of notice actions;
segmenting said characterized data into groupings according to one or more variables; and
reporting results of said notice effectiveness.

12. The method according to claim 11, wherein said segmenting is based upon a set of variables comprising time period, type of asset and internet Service provider (ISP).

13. The method according to claim 11, wherein said randomization methodology is a grouping of said unauthorized distributors into at least two groups, said groups comprising a notice group and a no-notice group.

14. The method according to claim 11, wherein said variables comprises at least one of statistical summary of unauthorized distribution actions by digital asset type, infringement duration by digital asset type, notice actions by digital asset type, statistical summary of unauthorized distribution actions by unauthorized distributor type, infringement duration by unauthorized distributor type, notice actions by unauthorized distributor type.

15. The method according to claim 11, wherein said groupings of unauthorized distributors are comprised of at least one of one-time peers, casual peers, and recidivist peers.

16. A system for combating unauthorized distribution of content files on a peer-to-peer network, the system comprising:
a storage medium containing peer information of peers participating in said peer-to-peer network for said content files;
a computer readable medium comprising computer executable instructions processing said peer information and apriori information that uniquely identifies individual unauthorized distributors, issuing notices to some of said unauthorized distributors, further comprising characterizing said unauthorized distributors and segmenting said unauthorized distributors into groups; and
a display for reporting results of said processing.

17. The system of claim 16, wherein said characterizing is based on overall data from at least one of characterization of unauthorized distribution activity and characterization of notice actions.

18. The system according to claim 16, wherein said grouping of the unauthorized distributors is accomplished by a randomization strategy

19. The system according to claim 18, wherein said grouping provides for at least two groups, said groups comprising a notice group and a no-notice group.
